(19) United States
(12) Patent Application Publication
(10) Pub. No.: US 2001/0008345 A1
(43) Pub. Date: Jul. 19, 2001

(54) Actuation arrangement for hinged components on vehicles

(76) Inventors: Klaus Stolle, Schwabniederhofen (DE); Wolfgang Kladiwa, Huglifing (DE); Anton Hollerbach, Schongau (DE); Bernhard Hollerbach, Steingaden (DE)

Correspondence Address: Dykema Gossett PLLC, Suite 300 West, 1300 I Street, N.W., Washington, DC, 20005-3306, US

(21) Appl. No.: 09/756,654

(22) Filed: Jan. 10, 2001

(30) Foreign Application Priority Data
Jan. 14, 2000 (AT) A 60/2000

(51) Int. Cl. B60J 7/12

(52) U.S. Cl. 296/107.01; 296/117; 296/76

(57) ABSTRACT

An actuation arrangement for hinged components on vehicles such as rear covers, trunk lids, covers for convertible tops or convertible top components themselves, having at least one fluid drive engaging the hinged component directly or indirectly, the fluid drive of the arrangement driving a rotary shaft (W) to realize a constant moment at a small mounting space as wells as a suitable configuration for principally any rotation angle. The rotary shaft, which lies in the swiveling axis (A) of the hinged component (V), is non-rotatably connected to the hinged component (V), possibly via an interconnected lever (H).

### BACKGROUND OF THE INVENTION

1. Field of the Invention

The invention relates to an actuation arrangement for hinged components on vehicles, particularly for actuation of rear covers, trunk lids, covers for convertible tops or convertible components themselves, having at least one fluid drive engaging the hinged component directly or indirectly.

2. The Prior Art

For actuation of movable, particularly hinged vehicle components, conventional fluid drives in the form of working cylinders are employed which are joined with one end to the vehicle body, and with the other end, mostly the outer end of the piston rod, they engage the component to be moved. This approach (in design) is normally customary for trunk lids and engine compartment hoods, for covers of tops of convertible automobiles, but also for foldable sections of the convertible top itself, especially for hard tops and similar constructions. However, this approach has some disadvantages, for instance, the greatest forces are necessary at the beginning and at the end of their movement based on the kinematics of the hinged components. These demands cannot be sufficiently satisfied based on the possible arrangement of the working cylinders in the region of the swiveling axes. The created moment during the rotating motion is also not constant based on the deflection. Moreover, these drives may be practically employed only for swiveling angles that are smaller than 180° and they need a relatively large mounting space. This latter disadvantage becomes especially apparent during planning of a cover for the entire drive arrangement where it becomes of particular significance to avoid injuries or catching items. There is also relatively little space available in the area of the (occupant's) head for the actuation arrangement of convertible folding tops so that multiple folding versions could heretofore not be operated in this manner, particularly the ones with solid and thereby heavy components, because the necessary strong cylinders effecting simultaneously large swiveling movements could not be installed therein.

It is the object of the present invention to design an actuation arrangement of the type mentioned above which will avoid the above disadvantages yet produce a constant moment having a small mounting space requirement and which will be principally suitable at any swiveling angle.

### SUMMARY OF THE INVENTION

This object is achieved with an actuation arrangement wherein the fluid drive drives a rotary shaft which lies in the swiveling axis of the hinged component and which is non-rotatably connected to the hinged component, possibly via an interconnected lever. Complex arrangements and arrangements with lever systems needing a large mounting space or the like are avoided. The lever in the arrangement, according to the invention, is merely an extension to make the coupling of the component easier. At the smallest mounting space—and thereby at the (occupant's) head region of convertible tops as well—swiveling movements of the actuated vehicle component may be performed essentially at any angle range.

According to a first embodiment, the fluid drive is provided with a hydraulic motor which drive shaft is connected to a rotary shaft for the hinged component, possibly via preferred mechanical gears. This embodiment makes possible a compact and a very simple configuration version.

An additional simplification, reduction of the number of necessary components, and reduction in size of the arrangement is possible when the fluid drive is provided with a hydraulic motor which drive shaft is at the same time the rotary shaft for the hinged component.

The fluid drive is advantageously provided with a rotary piston motor in a housing having at least one rotary piston, which is swivable on a rotary axis between two strokes by means of the pressure medium, whereby the rotation axis of one or each rotary piston is preferably also the rotary shaft. Thereby there can be achieved a large effective working surface for the pressure fluid to act upon and large forces are created even at a compact design.

The piston of the rotary piston motor is thereby designed preferably in form of at least one wing whereby this wing is non-rotatably held in place on the rotation axis.

The actuation arrangement, according to the invention, is functional and simpler relative to the achievement of the necessary sealing qualities of the working chambers of the hydraulic cylinder when, according to an additional characteristic of the invention, the fluid drive is provided with a linear working cylinder whose piston rod rotates the rotary shaft via mechanical gears during its linear working stroke. Linear drives are problem-free in their production and operation and they are suitable for heavy use over a long period. The targeted forces for all applications are sufficiently large with a correspondingly large cross-sectional dimension of the piston.

According to a very simple and operational safe preferred embodiment, the piston rod is designed in form of a toothed rack, at least at its outer end, or it is rigidly connected with a toothed rack. A pinion gear engages the teeth of the toothed rack whereby the pinion gear is non-rotatably attached to the rotary shaft.

It is advantageously proposed in a configuration of the above actuation arrangement, particularly at the outer areas or the corner area of the moving component, such as the comers of a trunk lid or a convertible top cover joined to the vehicle, that the pinion gear is attached to one end of the rotary shaft whereby the second end of the rotary shaft is non-rotatably connected to the movable component. Coupling of the movable component is thereby made possible only from one direction, perpendicular to the longitudinal axis of the actuation arrangement, and therefore its installation into the side areas of the vehicle is made possible as well.

According to an additional characteristic of the invention, the toothed rack is guided in a guide track in the longitudinal direction whereby the guide track is preferably adjustably mounted in the direction of the pinion gear, preferably by means of screws. The play between teeth may thereby be adjusted accurately and if necessary minimized or avoided at all.

Optimum protection for the actuation arrangement itself and thereby an unrestricted and trouble free operation is provided, as well as protection from injuries for users or protection for other items from damage by the actuation arrangement, is also provided when the piston rod, the section of the rotary shaft cooperating therewith, and all interconnected components are under one cover.

Protection of this type may be achieved in a simple manner by means of a cover, if this cover is an extension of the housing or the barrel of the hydraulic cylinder.

Another mechanical conversion of the movement of any fluid drive into a suitable rotary motion of the rotary shaft is made possible in that the hydraulic motor and the rotary shaft are connected by a mechanical worm gear whereby this configuration allows relatively small cross-sectional dimension of the arrangement across its longitudinal axis and it allows the conversion of high-speed rotations into slower rotations occurring at a smaller angle range.

Orientation of the rotary shaft in a larger angle range is possible relative to the longitudinal axis of the hydraulic cylinder or the drive shaft or each hydraulic motor, and possible is also a displacement of these components if the hydraulic motor and the rotary shaft are connected via a bevel gear.

The actuation arrangement, according to the invention, may be employed very advantageously as replacement for conventional hinges if the rotary shaft supports, at least partly, the hinged component directly or indirectly through at least one lever, which is firmly connected to said hinged component. Aside of the small space requirement of the fluid drive, compared to the usual hinges, for example, the often times unfavorable force distribution of hinges may be avoided and a better and smoother course of movement for the hinged component may be achieved.

The actuation arrangement, according to the invention, may be advantageously used for the actuation of at least one part of a convertible top whereby its fluid drive forms the main bearing for the convertible top. Mounting space is thereby saved and the course of movement of the convertible can be improved.

According to an additional characteristic of the invention, a rotation sensor pis employed which is preferably coupled with the rotary shaft, the rotation axis of the hydraulic motor, or the rotary piston motor so that in a simple and accurate manner the movement of the component to be actuated by the actuation arrangement is detected or whereby the sensor may be used to assist in the control of the pressure medium or in other movement processes, depending on the moved component and its position.

The invention is described in more detail in the following description with the aid of preferred embodiment examples, which are illustrated in the accompanying drawings.

### BRIEF DESCRIPTION OF THE DRAWINGS

FIG. 1 shows thereby a schematic illustration of a fluid drive, according to the invention, in the use on a trunk lid;

FIG. 2 is a schematic illustration of two fluid drives, according to the invention, on a convertible top;

FIG. 3 is a top view of an especially preferred embodiment of a fluid drive having a linear working cylinder, a toothed rack, and a pinion gear;

FIG. 4 is a longitudinal sectional view through the fluid drive in FIG. 3;

FIG. 5 shows a sectional view perpendicular to the longitudinal axis of the hydraulic cylinder in FIG. 3 at the point of the rotary shaft;

FIG. 6 is a sectional view through an actuation arrangement, according to the invention, in form of a rotary piston motor; and

FIG. 7 is a sectional view along the line 7-7 in FIG. 6.

### DETAILED DESCRIPTION OF THE PREFERRED EMBODIMENTS

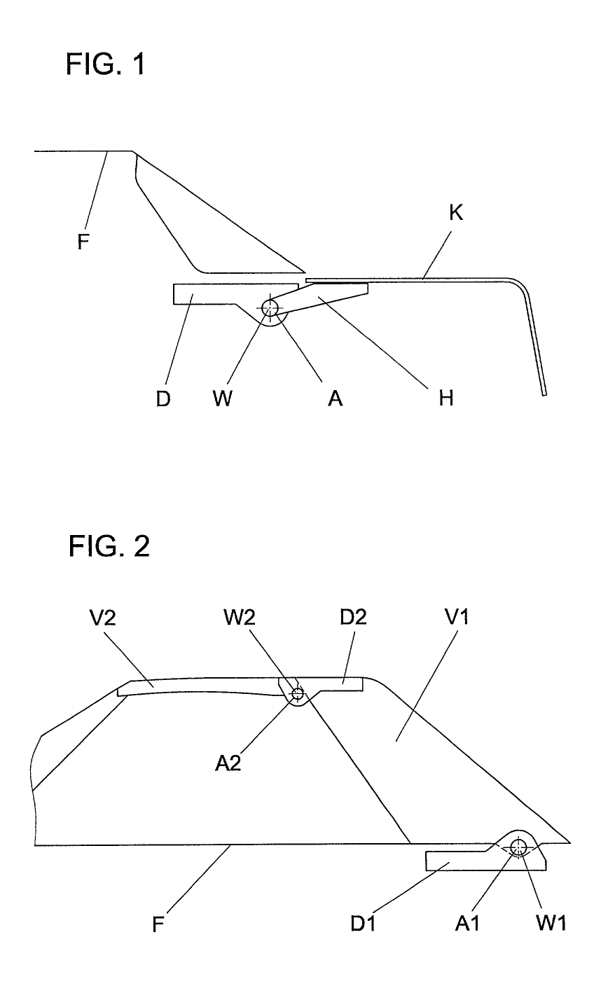

FIG. 1 shows at least one fluid drive D attached to the body of a vehicle F, i.e., in the region of the upper front end of the rear fender, whereby the rotary shaft W of the fluid drive D lies in the swiveling axis A of the trunk lid K. It supports its weight at the same time. A lever H, indirectly supporting the trunk lid K and transmitting the force of the fluid drive D, is non-rotatably connected to the rotary shaft W. The fluid drive D advantageously replaces thereby the conventional hinges, which often times have unfavorable bearings, and the fluid drive uses less space since the hinge may be completely replaced by it. The actuation arrangement, according to the invention, may also be employed of course without supporting function in addition to the conventional hinges or the like.

However, the novel fluid drive may also be used for actuation of a convertible top, as shown schematically in FIG. 2. In the area of the fender of the vehicle F, for example, a first fluid drive D1 attached to the vehicle's body as the main bearing for the top V1 and V2 whereby it moves with its rotary shaft W1 a first top section V1 on its swiveling axis A1, which corresponds to the axis of the rotary shaft W1. A second top section V2, here the actual roof of the vehicle, is swivable on the swiveling axis A2 at the upper front end of the first top section V1, for which a second fluid drive D2 is advantageously provided based on the small mounting space and the need for a constant moment over the entire angle range of the swiveling process. The second fluid drive's rotary shaft W2 lies exactly in the swiveling axis A2 for the second top section V2. In convertible automobiles, the fluid drive can form in an advantageous manner the main bearing for the (convertible) top and all moving parts connected thereto, whereby the advantages of space savings and favorable moments become especially of significance.

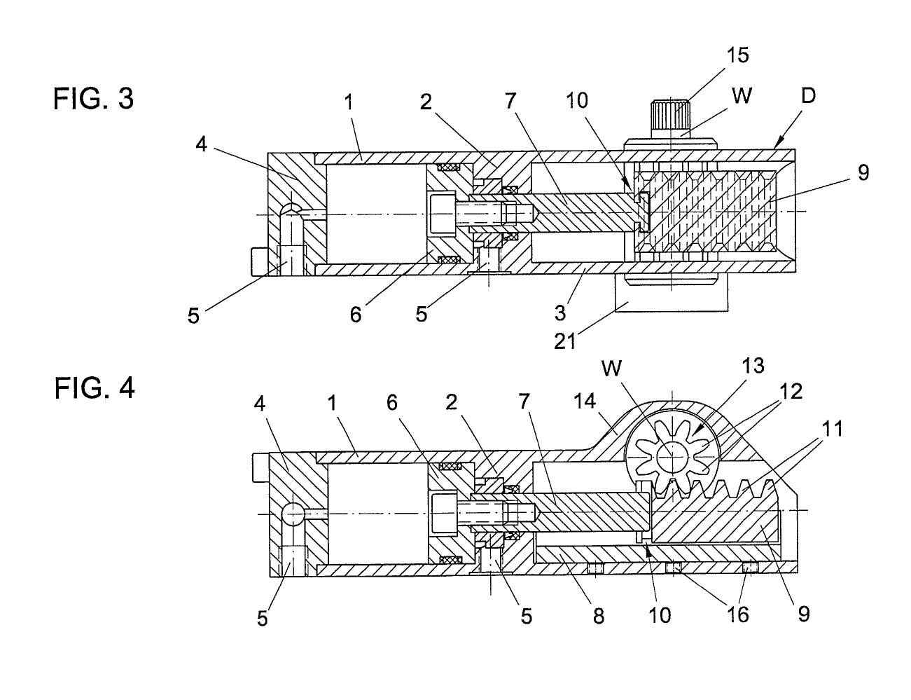

An embodiment example of a novel fluid drive D, having a linear hydraulic motor, is illustrated in FIGS. 3 though 5 and it is described below. A cover 2 of a hydraulic cylinder is provided in a center area of a cylinder barrel 1 having a preferably circular cross section. Furthermore, the cylinder barrel 1 is provided advantageously with an extension 3, which forms a housing that is joined to the cover 2. On the side of the cover area opposite the extension 3 there is a cylinder bottom 4 provided, which is connected to the cylinder barrel 1 whereby the bottom 4 may be possibly designed as one piece together with the cylinder barrel 1. The pressure medium, preferably hydraulic oil, in the working chambers of the hydraulic cylinders may be supplied or drawn out through the passages 5 in the bottom 4 and in the cover area 2. The piston 6 is displaced axially within the cylinder barrel 1 by the pressure medium and the piston rod 7 attached firmly to the piston 6 moves there as well, whereby the piston rod 6 protrudes into the housing formed by the extension 3 and is guided through the cover area 2 in a sealed condition.

The extension 3 is at the same time a guide, or it contains a guide track 8 for a toothed rack 9, which is tightly connected with the piston rod 7, for example via a detachable connection 10 in form of a disk-shaped end of the piston rod 7, which is slidably received in a narrow groove of the toothed rack 9. Distortion between the two parts is avoided in this manner as well.

The teeth 11 of the toothed rack 9 mesh with the teeth 12 of a pinion gear 13, which is non-rotatably attached to the rotary shaft W. The rotary shaft W rotates on bearings within two bracket-type components 14 of the extension 3, perpendicular to the longitudinal axis of the cylinder barrel 1, and thereby perpendicular to the piston rod 7 as well. The rotary shaft W has teeth 15 preferably on its outer end so that the lever H may be connected non-rotatably to the rotary shaft W in a simple manner. However, the non-rotatable connection could be established also by any other positive or non-positive manner.

An additional advantage of the fluid drive—in all applications—is that the simple connection, having a rotation sensor 21 for control and monitoring of the movement of the hinged components on the vehicle, may be connected to the control electronics of the actuation arrangement. As illustrated in FIG. 3, the rotation sensor 21 is coupled directly to a rotary shaft W or the drive shaft of any desired hydraulic motor or it cooperates with components thereof.

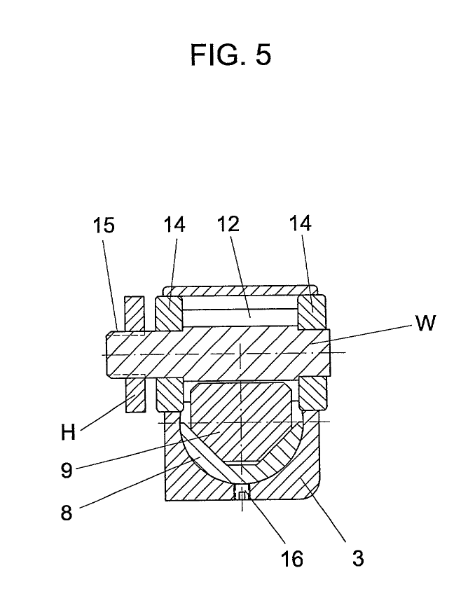

In the cross-sectional view in FIG. 5 there can be seen a lever H coupled to the rotary shaft W as well as the rotatable bearing in the bracket-type components 14. Furthermore, there can be seen the guide track 8, which has a trapezoid cross section facing with its open end the toothed rack 9 and which cooperates with the trapezoid bottom side of the toothed rack 9 to safely prevent turning and twisting of the toothed rack and to maintain meshing of the toothed rack 7 with the pinion gear 13. The guide track 8 may be pulled out of the extension 3, whereby the toothed rack 9 drops down, and thus the detachable connection 10 can be loosened and the toothed rack 9 may be separated from the piston rod 7. During operation, the guide track is held in place and fixed in the extension 3 by a plurality of headless screws 18. By means of the screws 16, the guide track 8 and the bearings thereof may be adjusted in a direction predetermined by the longitudinal axis of the screw 16. The play between the guide track 8 and the pinion gear 13 may be accurately adjusted and advantageously minimized thereby.

The guide track for the toothed rack 9 may of course be formed by the inner side of the extension 3 itself or by an inserted guide together with a part of the inner surface of the extension 3. The shape of the cross section and the teeth of the toothed rack 9 and/or the pinion gear 13 may also be modified according to respective requirements. Other mechanical transmissions between the toothed rack 7 and the rotary shaft W are also possible, such as worm gears or bevel gears, for example, which are of special advantage if the rotary shaft W is not exactly perpendicular to the longitudinal axis of the hydraulic cylinder, but where it is necessary to have angles ≠90° or displacements between the piston rod 7 and the rotary shaft W.

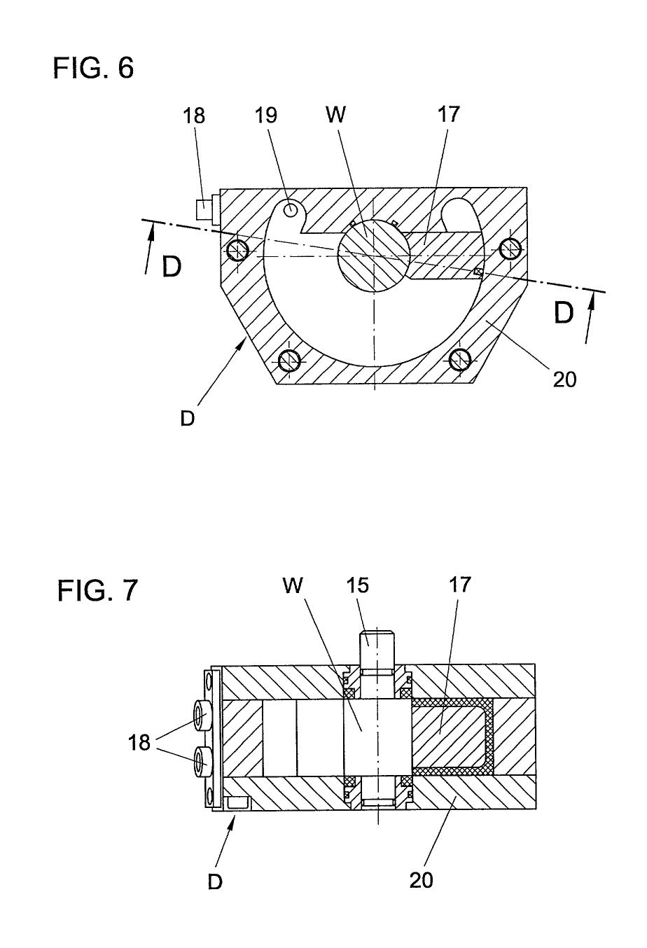

FIGS. 6 and 7 show an actuation arrangement having a fluid drive D in form of a rotary piston cylinder. A shaft is thereby rotatably seated in a housing 20 whereby the shaft is at the same time the rotary shaft W of the fluid drive D and, as already described above, it is provided at one end, which is protruding from the housing 20, preferably with teeth 15 or a similar or functionally equally effective connecting structure. Through the teeth 15 there is established the direct connection of the fluid drive D to the swivable component V or the indirect connection via an interconnected lever H. A piston in form of a wing 12 is non-rotatably mounted on the rotary shaft W inside the housing 20, where the wing 12 separates two working chambers inside the housing. The working chambers at both sides of the wing 17 may be biased with the pressure medium via the connections 18 and the supply opening 19 (only one of them may be seen in FIG. 6) whereby the wing 17 may be moved and thusly rotates the rotary shaft W about its axis.

In place of the above-described and in the drawing illustrated version, all other types of hydraulic motors may be employed in principal, such as rotary geared motors, wing-cell motors, axial- or radial piston motors, or linear-operating thrust piston motors also without a piston rod but acting upon a lever, which converts the transferred force into a rotating motion with a shaft that is non-rotatably connected to a lever. The drive shaft of the hydraulic motors may also be connected to the rotary shaft (W) of the hinged component (V) via worm gears or bevel gears and/or via reducing gears or transmission gears, preferably on a mechanical basis; however, the drive shafts may also be directly the rotary shaft (W) itself.

The rotary shaft W may naturally be engaged not only by a fluid drive but there can be provided a plurality of parallel drives to create higher moments, for instance. Two linear drives may act upon the rotary shaft via separate gears, for example, or the linear drives may engage the same gear to increase the existing moment. As an additional example, it would be conceivable that a rotary shaft W is provided for each pinion gear 13 on top of each other and disposed at opposite sides of the toothed rack 9, preferably parallel to each other, and which are moved by the piston rod 7 of a respective linear working cylinder, which in turn are preferably also disposed parallel to each other.

We claim:

1. An actuation arrangement for hinged components on vehicles such as rear covers, trunk lids, covers for convertible tops or convertible components themselves, having at least one fluid drive engaging the hinged component directly or indirectly, wherein a fluid drive (D) drives a rotary shaft (W), which lies in a swiveling axis (A) of the hinged component (V) and which is non-rotatably connected to said hinged component via an interconnected lever (H).

2. An actuation arrangement according to claim 1, wherein the fluid drive (D) includes a hydraulic motor which drive shaft is connected to a rotary shaft (W) for the hinged component (V) via mechanical gears.

3. An actuation arrangement according to claim 1, wherein the fluid drive (D) includes a hydraulic motor whose drive shaft is preferably the rotary shaft (W) for the hinged component (V) at the same time.

4. An actuation arrangement according to claim 1, wherein the fluid drive (D) includes a rotary piston motor in a housing (20) having at least one rotary piston (17), which is swivable on a rotary axis between two strokes by means of the pressure medium, whereby the rotation axis of one or each rotary piston is also the rotary shaft (W).

5. An actuation arrangement according to claim 4, wherein the piston of the rotary piston motor is designed in form of at least one wing (17) and whereby said wing (17) is non-rotatably held in place on the rotation axis.

6. An actuation arrangement according to claim 1, wherein the fluid drive D includes a linear working cylinder (1-7) which piston rod rotates said rotary shaft (W) via mechanical gears (9, 13) during its linear working stroke.

7. An actuation arrangement according to claim 6, wherein said piston rod (7) is designed in form of a toothed rack (9), at least at its outer end, or it is rigidly connected to a toothed rack, wherein a pinion gear (13) engages the teeth of said toothed rack, and wherein said pinion gear is non-rotatably attached to said rotary shaft (W).

8. An actuation arrangement according to claim 7, wherein said pinion gear (13) is attached to one end of said rotary shaft (W) and wherein the second end of the rotary shaft is non-rotatably connected to the movable component (V).

9. An actuation arrangement according to claim 8, wherein said toothed rack (9) is guided in a guide track (8) in the longitudinal direction, and wherein said guide track (8) is preferably mounted adjustably in the direction of the pinion gear (13), preferably by means of screws (16).

10. An actuation arrangement according to claim 6, wherein said piston rod (7), the section of said rotary shaft (W) cooperating therewith, and all interconnected components are under one cover.

11. An actuation arrangement according to claim 10, wherein said cover is an extension (3) of the housing or the barrel (1) of said hydraulic cylinder.

12. An actuation arrangement according to claim 2, wherein said hydraulic motor and said rotary shaft (W) are connected to one another via a mechanical gear.

13. An actuation arrangement according to claim 2, wherein said hydraulic motor and said rotary shaft (W) are connected to one another via a bevel gear.

14. An actuation arrangement according to claim 1, wherein said rotary shaft (W) supports, at least partly, the hinged component (K, V) directly or indirectly through at least one lever (H), which is firmly connected to said hinged component (K, V).

15. An actuation arrangement according to claim 1 for actuation of at least one part of a convertible top, wherein said fluid drive (D) forms the main bearing for said convertible top.

16. An actuation arrangement according to claim 1, wherein a rotation sensor (21) is provided which is coupled with said rotary shaft (W), the rotation axis of the hydraulic motor, or the rotary piston motor.
